(19) United States
(12) Patent Application Publication
(10) Pub. No.: US 2014/0326100 A1
(43) Pub. Date: Nov. 6, 2014

(54) DRIVING MECHANISM

(71) Applicants: Hong Fu Jin Precision Industry (ShenZhen) Co., Ltd., Shenzhen (CN); Hon Hai Precision Industry Co., Ltd., New Taipei (TW)

(72) Inventors: CHIA-PENG DAY, Santa Clara, CA (US); XIAO-MING XU, Shenzhen (CN); HUA HUANG, Shenzhen (CN)

(73) Assignees: HONG FU JIN PRECISION INDUSTRY (ShenZhen) CO., LTD., Shenzhen (CN); HON HAI PRECISION INDUSTRY CO., LTD., New Taipei (TW)

(21) Appl. No.: 14/270,458

(22) Filed: May 6, 2014

(30) Foreign Application Priority Data
May 6, 2013 (CN) 2013101620026

(51) Int. Cl. B23Q 16/00

(52) U.S. Cl. CPC B23Q 16/00
USPC 74/490.09

(57) ABSTRACT

Driving mechanism without gears or other meshing structures which can operate in restricted environments includes a first linear driving module, a second linear driving module coupled to the first linear driving module, and a third linear driving module coupled to the second linear driving module. The first linear driving module is configured to drive the second linear driving module to move along the first linear driving module. The second linear driving module is configured to drive the third linear driving module to move long the second linear driving module. A driving direction of the third linear driving module is inclined relative to a plane parallel to directions of the first and second linear driving modules.

### CROSS-REFERENCE TO RELATED APPLICATIONS

This application is related to three co-pending U.S. patent applications (Attorney Docket Nos. US51918, US51919, US51921), entitled “DRIVING MECHANISM”, “ROBOT”, “THREE-AXES ROBOT”, respectively, by Day et al. The applications have the same assignee as the instant application and are concurrently filed on the same day. The disclosure of the above-identified applications is incorporated herein by reference.

### FIELD

The present disclosure relates to driving mechanisms, and particularly to a driving mechanism capable of driving along multiple directions.

### BACKGROUND

A driving mechanism can be applied to industrial processes, and particularly applied to heavy processes, repetitive processes, or special process environments, for example. A driving mechanism can be used in the assembly of an electronic device, for example a mobile phone. However, electronic devices for example smart phones and tablet computers are gradually becoming thinner. Thus, the assembling, machining, or handling of the electronic devices becomes harder and requires greater precision. Driving mechanisms may use plurality of gears or reducers for transmitting movements. However, such driving mechanisms produces a lot of vibrations. The gears and the reducers are very heavy, such that inertia of the driving mechanism is large. Additionally, elements of the electronic devices are very small and the fitting space associated therewith is small. Thus, the driving mechanisms can be restricted to electronic devices.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 is an isometric view of a first embodiment of a driving mechanism.

FIG. 2 is an exploded, isometric view of the driving mechanism of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

The term “coupled” is defined as being connected whether directly, or indirectly through intervening components, and is not necessarily limited to physical connections. The connection can be such that objects are permanently connected or releasably connected.

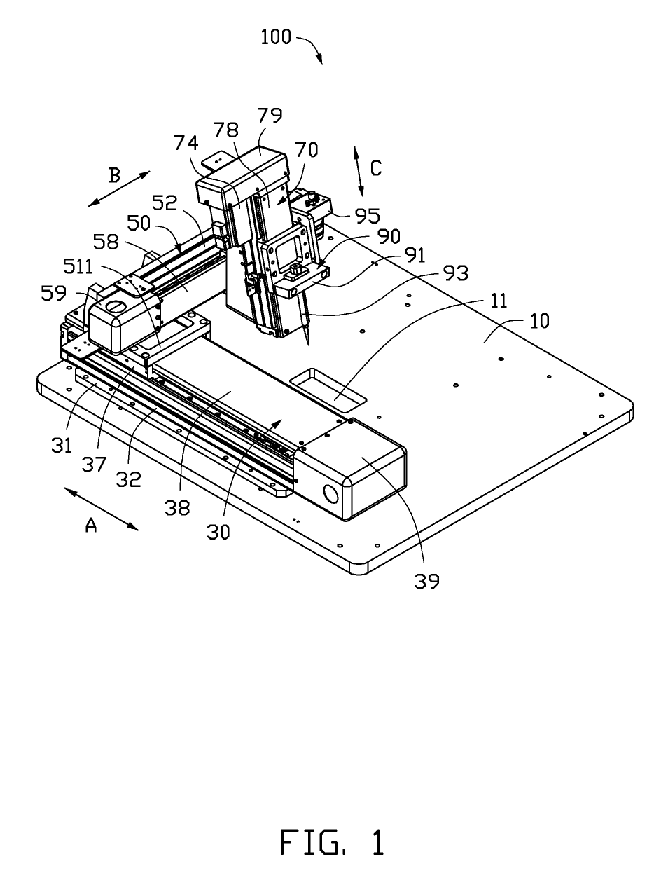

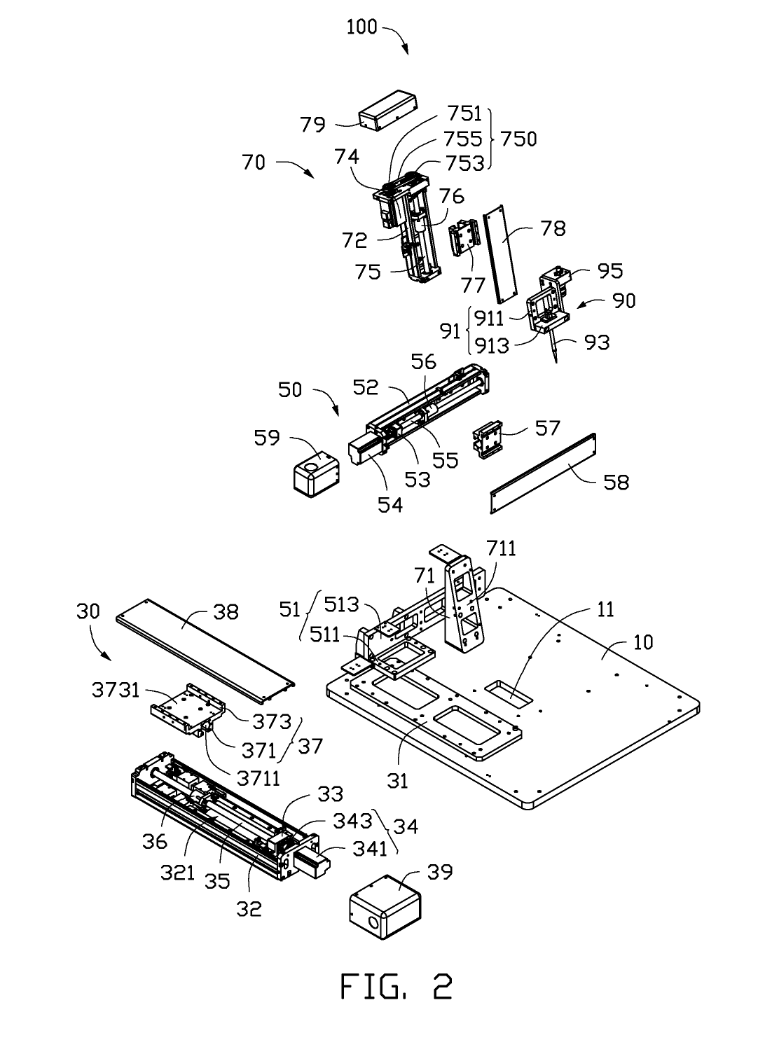

FIGS. 1 and 2 illustrate an embodiment of a driving mechanism 100. The driving mechanism 100 includes a support member 10, a first linear driving module 30, a second linear driving module 50, and a third linear driving module 70. The first linear driving module 30 can be mounted on the support member 10. The second linear driving module 50 can be mounted on the first linear driving module 30. The third linear driving module 70 is mounted on the second linear driving module 50 and configured to couple with an actuating mechanism 90. The first linear driving module 30 can drive the second linear driving module 50 along a first direction A. The second linear driving module 50 can drive the third linear driving module 70 along a second direction B. The third linear driving module 70 can drive the actuating mechanism 90 along a third direction C. Thus, a driving direction of the third linear driving module 70 is along the direction C, a moving direction of the second linear driving module 50, which is driven by the first linear driving module 30 is along the direction A, and a moving direction of the third linear driving module 70 driven by the second linear driving module 50 is along the direction B. A driving direction of the third linear driving module 70 can be inclined relative to a plane parallel to the first direction A and the second direction B. Because the third linear driving module 70 can also move along the direction A driven by the first linear driving module 30 via the second linear driving module 50, the driving direction of the third linear driving module 70 can be inclined relative to a plane parallel to the moving directions of direction A and the direction B. In the illustrated embodiment, the first direction A is perpendicular to the second direction B. The third direction C is non-vertically perpendicular to the second direction B, but not perpendicular to the first direction A. In the illustrated embodiment, the first direction A and the second direction B are parallel to the support member 10. The third direction C is inclined relative to the support member 10.

The support member 10 can be substantially a rectangular plate, and configured to be assembled on a worktable when in use. The support member 10 can support the first linear driving module 10, the second linear driving module 30, and the third linear driving module 70. The support member 10 can define a position hole 11 for positioning a workpiece (not shown).

The first linear driving module 30 can include a connecting member 31, a mounting member 32, a connection reinforcing member 33, a driving member 34, a first transmission member 35, a second transmission member 36, a third transmission member 37, a protecting plate 38, or a protecting cover 39. The connecting member 31 can be substantially a rectangular plate. The connecting member 31 can be mounted on the support member 101 along the first direction A and located adjacent to an edge of the support member 101. The mounting member 32 can be substantially a frame, and can define an opening 321 for mounting the connection reinforcing member 33, the driving member 34, the first transmission member 35, the second transmission member 36, the third transmission member 37, and the protecting plate 38. The mounting member 32 can be coupled to the connecting member 31 by fasteners for example. A longitudinal direction of the mounting member 32 can be parallel to the first direction A.

The connection reinforcing member 33 can be fixed to a distal end of the mounting member 32 and received in the opening 321. The driving member 34 can include a driving body 341 and a driving end 343 protruding from the driving body 341. The driving body 341 can be mounted on an end wall of the mounting member adjacent to the connection reinforcing member 33. The driving end 343 can be inserted through the end wall of the mounting member 32 and driving end 343, to extend to the connection reinforcing member 33. Thus, the driving end 343 can be received in the mounting member 32. The first transmission member 35 can be substantially a rod and positioned in the mounting member 32 along the first direction A. A first end portion of the first transmission member 35 can be rotatably coupled to a wall of the mounting member 32 away from the connection reinforcing member 33, and a second end portion of the first transmission member 35 can be inserted through the connection reinforcing member 33 and coupled to the driving end 343 of the driving member 34. The connection reinforcing member 33 can be rotatably sleeved on a connecting portion of the first transmission member 35 and the driving end 343 for strengthening a connection between the first transmission member 35 and the driving end 343. The driving body 341 can rotate the driving end 343. Thus, the driving end 343 rotates the first transmission member 35. In the illustrated embodiment, the driving member 34 is a motor. The first transmission member 35 is a guiding lead screw.

The second transmission member 36 can be substantially cylindrical and rotatably sleeved on the first transmission member 35 and threaded with the first transmission member 35. The third transmission member 37 can include a first fixing portion 371 and a second fixing portion 373 located upon the first fixing portion 371. The first fixing portion 371 can be substantially cylindrical, and define a through hole 3711 along a center axis thereof. The through hole 3711 can match with the second transmission member 36, and the first fixing portion 371 can be fixedly sleeved on the second transmission member 36 via the through hole 3711. The second fixing portion 373 can be substantially cuboid. Opposite sides of the second fixing portion 373 can be supported on sides of the mounting member 32 along the first direction A, such that the mounting member 32 can guide the second fixing portion 373 in operation. The second fixing portion 373 can define a receiving groove 3731 at a top surface. The protecting plate 38 can be a plate matching with the mounting member 32 and fixed on the mounting member 32. The protecting plate 38 can be partly received in the receiving groove 3731 to cover the opening 321, to prevent dust or grease entering into the mounting member 32. The protecting cover 39 covers the driving body 341 of the driving member 34, thereby preventing dust or grease from entering into the driving body 341.

A structure of the second linear driving module 50 can be similar to the first linear driving module 30. Thus, an explanation of the second linear driving module 50 is not required. The second linear driving module 30 can include a connecting member 51, a mounting member 52, a connection reinforcing member 53, a driving member 54, a first transmission member 55, a second transmission member 56, a third transmission member 57, a protecting plate 58, and a protecting cover 59. The connecting member 51 can be a frame and include a first connecting portion 511 and a second connecting portion 513 fixedly coupled to the first connecting portion 511. The first connecting portion 511 can be a substantially rectangular frame and parallel to the support member 101. The first connecting portion 511 can be fixedly coupled to the second fixing portion 373 of the third transmission member 37. Thus, the connecting member 51 can move along the first direction A with the third transmission member 37. The second connecting portion 513 can be perpendicular to the first connecting portion 511, and a first end of the second connecting portion 513 can be coupled to the first connecting portion 511. A longitudinal direction of the second connecting portion 513 can be parallel to the second direction B. The respective structures or coupling relationships of the mounting member 52, the connection reinforcing member 53, the driving member 54, the first transmission member 55, the second transmission member 56, the third transmission member 57, the protecting plate 58, and the protecting cover 59 are the same as those of the mounting member 32, the connection reinforcing member 33, the driving member 34, the first transmission member 35, the second transmission member 36, the third transmission member 37, the protecting plate 38, and the protecting cover 39. Thus, explanations are omitted. The first transmission member 55 of the second linear driving module 50 can be positioned along the second direction B.

A structure of the third linear driving module 70 can be similar to that of the first linear driving module 30 and the second linear driving module 50. Thus, an explanation of the third linear driving module 70 is simplified. The third linear driving module 70 can include a connecting member 71, a mounting member 72, a driving member 74, a first transmission member 75, an intermediate transmission assembly 750, a second transmission member 76, a third transmission member 77, a protecting plate 78, and a protecting cover 79. The connecting member 71 can be a substantially triangular prism and mounted on the third transmission member 57 of the second linear driving module 50, perpendicular to the support member 101. The connecting member 71 can include an inclined surface 711. The inclined surface 711 can be located at a side of the connecting member 71 away from the third transmission member 57. The inclined surface 711 can be inclined relative to the support member 101. A distance between the inclined surface 711 and the third transmission member 57 of the second linear driving module 50 can increase along a direction towards the support member 10. The inclined surface 711 can be positioned along the third direction C. The mounting member 72 can be fixed to the inclined surface 711. The driving member 74 can be mounted at a side surface of the mounting member 72 and parallel to the mounting member 72. The first transmission member 75 can be a rod, and opposite ends thereof can be mounted at sidewalls of the mounting member 72. The first transmission member 75 can be located along the third direction C.

The intermediate transmission assembly 750 can include a first transmission pulley 751, a second transmission pulley 753, and a transmission belt 755. The first transmission pulley 751 can be sleeved on a driving end of the driving member 74. The second transmission pulley 753 can be sleeved on a first end of the first transmission member 75 adjacent to the driving member 74. The transmission belt 755 can be sleeved on the first transmission pulley 751 and the second transmission pulley 753. The driving member 74 can rotate the first transmission pulley 751, and then the first transmission member 75 can be rotated by the transmission belt 755 and the second transmission pulley 753. The respective structures and coupling relationships of the first transmission member 75, the second transmission member 76, the third transmission member 77 and the protecting plate 78 can be substantially the same as those of first transmission member 35, the second transmission member 36, the third transmission member 37, and the protecting plate 38 of the first linear driving module 30. Thus, explanations of the first transmission member 75, the second transmission member 76, the third transmission member 77, and the protecting plate 78 are omitted. The first transmission member 75 of the third linear driving module 70 can be located along the third direction C. The protecting cover 79 can be mounted on a distal end of the mounting member 72 and cover the first transmission member 751, the second transmission member 753, and the transmission belt 755.

In assembly, the first linear driving module 30, the second linear driving module 50, and the third linear driving module 70 are installed. When assembling the first linear driving module 30, the mounting member 32 can be fixed to the connecting member 31. The connection reinforcing member 33 can be fixed within the mounting member 32. The driving member 34 can be mounted on the mounting member 32 and located adjacent to the connection reinforcing member 33. The first transmission member 35 can be received in the mounting member 32 along a longitudinal direction of the mounting member 32. Opposite ends of the first transmission member 35 can be movably inserted through the mounting member 32, and the first transmission member 35 can be coupled to the driving end 343 of the driving member 34. A connecting portion of the driving end 343 and the first transmission member 35 can be received in the connection reinforcing member 33. The second transmission member 36 can be sleeved on the first transmission member 35 and threaded with the first transmission member 35. The third transmission member 36 can be fixed to the second transmission member 36. The protecting plate 38 can pass through the receiving groove 3731 and cover the opening 321 of the mounting member 32. The protecting cover 39 covers the driving member 34. When assembling the second linear driving module 50, the mounting member 52 can be fixed to the second connecting portion 513 of the connecting member 51. Other assembly steps of the second linear driving module 50 can be the same as the assembly steps of the first linear driving module 30. When assembling the third linear driving module 70, the mounting member 72 can be mounted on the inclined surface 711. The driving member 74 can be mounted on a sidewall of the mounting member 72. The first transmission member 75 can be inserted through the mounting member 72. The first transmission pulley 751 and the second transmission pulley 753 can be sleeved on the driving member 74 and the first transmission member 75, respectively. The transmission belt 755 can be wound over the first transmission pulley 751 and the second transmission pulley 753.

The assembled first linear driving module 30 can be mounted on the support member 10. The first connecting portion 511 can be perpendicularly fixed to the third transmission member 37 of the first linear driving module 30. The first connecting portion 511 can be perpendicularly fixed to the third transmission member 37 of the first linear driving module 30. The second linear driving module 50 can be located above the first linear driving module 30. The first linear driving module 30 and the second linear driving module 50 can form an L-shape together. The connecting member 71 of the third linear driving module 70 can be mounted on the third transmission member 57 of the second linear driving module 50.

In operation, the actuating mechanism 90 can be mounted on the third linear driving module 70. In the illustrated embodiment, the actuating mechanism 90 can include a mounting frame 91, an actuating member 93, and a camera 95. The actuating member 93 and the camera 95 can be mounted on the mounting frame 91. The mounting frame 91 can include a first plate 911 and a second plate 913 fixed to the first plate 911. The first plate 911 can be fixed to the third transmission member 77 of the third linear driving module 70 along the third direction C, and thus the first plate 911 can be capable of moving along the third direction C when driven by the third transmission member 77. The second plate 913 can be perpendicular to the first plate 911. The actuating member 93 can be perpendicularly mounted on the second plate 913 and move along the third direction C with the mounting frame 91. In the illustrated embodiment, the actuating member 93 can be a probe for detecting the workpiece. In an alternative embodiment, the actuating member 93 can be some other tool, for example a pneumatic clamp, for assembling a workpiece with screws. The camera 95 can be fixed to the first plate 911 of the mounting frame 91. The camera can capture an image when the actuating member 93 detects the workpiece. A workpiece (not shown) can be positioned in the positioning hole 11, and the actuating member 93 of the actuating mechanism 90 can be located away from the positioning hole 11, to avoid disturbing the positioning of the workpiece.

After the workpiece has been positioned, the driving body 341 of the first linear driving module 30 can rotate the driving end 343. Thus, the third transmission member 37 can move along the first transmission member 35 when driven by the second transmission member 36. Because the first transmission member 35 is located along the first direction A, the third transmission member 37 also moves along the first direction A. The third transmission member 37 can move the second linear driving module 50 along the first direction A. Thus, the first linear driving module 30 can drive the second linear driving module 50, the third linear driving module 70, and the actuating mechanism 90 to move along the first direction A, such that the actuating mechanism 90 approaches the workpiece. In the same way, the second linear driving module 50 can move the third linear driving module 70 and the actuating mechanism 90 to move along the second direction B via the driving member 54, the first transmission member 55, the second transmission member 56, and the third transmission member 57, such that the actuating mechanism 90 approaches the workpiece. The driving member 73 can move the actuating mechanism 90 along the third direction C. The actuating mechanism 90 can detect the workpiece. The camera 95 of the actuating mechanism 90 is activated on detection of the workpiece.

Because the linear driving modules of the driving mechanism 100 are arranged on the support member 10 without interference, and the driving direction of the third linear driving module 70 is inclined, the driving mechanism 100 size is reduced. The driving mechanism 100 uses linear driving structures, without gears or any meshing structures, which decreases a size and weight of the driving mechanism 100. In addition, the third linear driving module 70 is inclined. Thus, the actuating mechanism 90 can be inserted into a complex workpiece, for example the actuating member 90 can conveniently be inserted into an inclined hole defined on an inner sidewall of the workpiece.

In an alternative embodiment, the connecting members 31, 51, 71, the connection reinforcing members 33, 53, the first transmission member 35, 55, 57, the second transmission members 36, 56, 76, the third transmission members 37, 57, 77, the first transmission pulley 751, the second transmission pulley 753, and the transmission belt 755 can be omitted, such that the mounting member 53 of the second linear driving module 50 can be directly coupled to the driving member 34, the mounting member 72 of the third linear driving module 70 can be directly coupled to the driving member 54, the actuating mechanism 90 can be directly coupled to the driving member 74, and the driving members 34, 54, 74 can be motors. For example, the driving member 34 can directly drive the second linear driving module 50 along the first direction A, the driving member 54 can directly drive the third linear driving module 70 along the second direction B, and the driving member 74 can directly drive the actuating mechanism 90 along the third direction C.

In an alternative embodiment, the third direction C can be inclined relative to the first direction A and the second direction B, and the inclined surface 711 can inclined relative to the first direction A and the second direction B. The first direction A can be non-perpendicular to the second direction B.

In an alternative embodiment, the first linear driving module 30, the second linear driving module 50, the third linear driving module 70, and the actuating mechanism 90 can be mounted on a top plate of a mounting frame (not shown). That is, the support member 10 can be replaced with the mounting frame and a workpiece can be positioned on a bottom plate of the mounting frame.

It is believed that the present embodiments and their advantages will be understood from the foregoing description, and it will be apparent that various changes can be made thereto without departing from the spirit and scope of the embodiments or sacrificing all of its material advantages.

What is claimed is:

1. A driving mechanism comprising:
a first linear driving module;
a second linear driving module coupled to the first linear driving module; and
a third linear driving module coupled to the second linear driving module,
wherein the first linear driving module is configured to drive the second linear driving module to move along the first linear driving module, the second linear driving module is configured to drive the third linear driving module to move long the second linear driving module, a driving direction of the third linear driving module is inclined relative to a plane parallel to moving directions of the third linear driving module.

2. The driving mechanism of claim 1, wherein the driving direction of the third linear driving module is inclined relative to a moving direction of the second linear driving module and perpendicular to a moving direction of the third linear driving module driven by the second linear driving module.

3. The driving mechanism of claim 2, wherein the third linear driving module further comprises a connecting member, the connecting member of the third linear driving modules is coupled to the mounting member of the second linear driving module;
the connecting member of the third linear driving module is perpendicular to the plane parallel to moving directions of the third linear driving module;
the connecting member of the third linear driving module comprises an inclined surface located at a side away from the mounting member of the second linear driving module;
the inclined surface is parallel to a driving direction of the third linear driving module; and
the mounting member of the third linear driving module is coupled to the inclined surface.

4. The driving mechanism of claim 3, wherein the third linear driving module further comprises a middle transmission assembly, a first transmission member, a second transmission member, and the third transmission member, the middle transmission assembly comprises a first transmission pulley, a second transmission pulley, and a transmission belt;
the first transmission member of the third linear driving module is received in the mounting member of the third linear driving module and opposite ends are inserted into the mounting member of the third linear driving module;
the first transmission pulley is sleeved on a driving end of the driving member of the third linear driving module;
the second transmission pulley is sleeved on the first transmission member of the third linear driving module;
the transmission belt winds on the first transmission pulley and the second transmission pulley;
the second transmission member of the third linear driving module is sleeved on the first transmission member of the third linear driving module and threaded with the first transmission member of the third linear driving module;
the third transmission member of the third linear driving module is fixed to the second transmission member of the third linear driving module.

5. The driving mechanism of claim 1 further comprising a mounting frame, wherein the first linear driving module is mounted on a top plate of the mounting frame, the first linear driving module, the second linear driving module, and the third linear driving module is received in the mounting frame.

6. The driving mechanism of claim 1, wherein each linear driving module of the first linear driving module, the second linear driving module, and the third linear driving module comprises a mounting member and a driving member mounted on the mounting member;
the mounting member of the second linear driving module is coupled to the driving member of the first linear driving module; and
the mounting member of the third linear driving module is coupled to the driving member of the second linear driving module.

7. The driving mechanism of claim 6, wherein the first linear driving module further comprises a first transmission member, a second transmission member, and a third transmission member;
the driving member of the first linear driving module is mounted at a distal end of the mounting member of the first linear driving module;
the first transmission member is received in the mounting member and coupled to the driving member;
the second transmission member is sleeved on the first transmission member and threaded with the first transmission member;
the third transmission member is fixed to the second transmission member; and
the mounting member of the second linear driving module is mounted on the third transmission member of the first linear driving module.

8. The driving mechanism of claim 7, wherein the first linear driving module further comprises a connection reinforcing member mounted within the mounting member of the first linear driving module;
the driving member comprises a driving body and a driving end coupled to the driving body;
the driving body is coupled to the mounting member of the first linear driving module;
the driving end is inserted into the mounting member of the first linear driving module and coupled to the first transmission member; and
the connection reinforcing member is rotatably sleeved on a connecting portion of the first transmission member and the driving end.

9. The driving mechanism of claim 7, wherein the mounting member of the first linear driving module defines an opening;
the third transmission member comprises a first fixing portion and a second fixing portion located upon the first fixing portion;
the first fixing portion is sleeved on the second transmission member;
opposite sides of the second fixing portion are supported on sides of the mounting member and the mounting member guides the second fixing portion;
the second fixing portion defines a receiving groove at a top surface thereof;
the first linear driving module further comprises a protecting plate matching with the mounting member;
the protecting plate is partly received in the receiving groove to cover the opening;
the mounting member of the second linear driving module is coupled to the second fixing portion.

10. The driving mechanism of claim 7, wherein the second linear driving module further comprises a connecting member, the connecting member of the second linear driving module comprises a first connecting portion and a second connecting portion perpendicularly fixed to the first connecting portion;
the first connecting portion is fixed to the third transmission member of the first linear driving module; and
the mounting member of the second linear driving module is fixed to the second connecting portion.

11. A driving mechanism comprising:
a support member;
a first linear driving module located on the support member;
a second linear driving module coupled to the first linear driving module; and
a third linear driving module coupled to the second linear driving module,
wherein the first linear driving module is configured to drive the second linear driving module to move along the first linear driving module, the second linear driving module is configured to drive the third linear driving module to move long the second linear driving module, a driving direction of the third linear driving module is inclined relative to the support member.

12. The driving mechanism of claim 11, wherein the driving direction of the third linear driving module is inclined relative to a moving direction of the second linear driving module and perpendicular to a moving direction of the third linear driving module driven by the second linear driving module.

13. The driving mechanism of claim 12, wherein the third linear driving module further comprises a connecting member, the connecting member of the third linear driving modules is coupled to the mounting member of the second linear driving module;
the connecting member of the third linear driving module is perpendicular to the plane parallel to moving directions of the third linear driving module;
the connecting member of the third linear driving module comprises an inclined surface located at a side away from the mounting member of the second linear driving module;
the inclined surface is parallel to a driving direction of the third linear driving module;
the mounting member of the third linear driving module is coupled to the inclined surface.

14. The driving mechanism of claim 13, wherein the third linear driving module further comprises a middle transmission assembly, a first transmission member, a second transmission member, and the third transmission member, the middle transmission assembly comprises a first transmission pulley, a second transmission pulley, and a transmission belt;
the first transmission member of the third linear driving module is received in the mounting member of the third linear driving module and opposite ends are inserted into the mounting member of the third linear driving module;
the first transmission pulley is sleeved on a driving end of the driving member of the third linear driving module;
the second transmission pulley is sleeved on the first transmission member of the third linear driving module;
the transmission belt winds on the first transmission pulley and the second transmission pulley, the second transmission member of the third linear driving module is sleeved on the first transmission member of the third linear driving module and threaded with the first transmission member of the third linear driving module;
the third transmission member of the third linear driving module is fixed to the second transmission member of the third linear driving module.

15. The driving mechanism of claim 11 further comprising a mounting frame, wherein the first linear driving module is mounted on a top plate of the mounting frame, the first linear driving module, the second linear driving module, and the third linear driving module is received in the mounting frame.

16. The driving mechanism of claim 11, wherein each linear driving module of the first linear driving module, the second linear driving module, and the third linear driving module comprises a mounting member and a driving member mounted on the mounting member;
the mounting member of the second linear driving module is coupled to the driving member of the first linear driving module; and
the mounting member of the third linear driving module is coupled to the driving member of the second linear driving module.

17. The driving mechanism of claim 16, wherein the first linear driving module further comprises a first transmission member, a second transmission member, and a third transmission member;
the driving member of the first linear driving module is mounted at a distal end of the mounting member of the first linear driving module;
the first transmission member is received in the mounting member and coupled to the driving member;
the second transmission member is sleeved on the first transmission member and threaded with the first transmission member; and
the third transmission member is fixed to the second transmission member, the mounting member of the second linear driving module is mounted on the third transmission member of the first linear driving module.

18. The driving mechanism of claim 17, wherein the first linear driving module further comprises a connection reinforcing member mounted within the mounting member of the first linear driving module;
the driving member comprises a driving body and a driving end coupled to the driving body;
the driving body is coupled to the mounting member of the first linear driving module;
the driving end is inserted into the mounting member of the first linear driving module and coupled to the first transmission member; and
the connection reinforcing member is rotatably sleeved on a connecting portion of the first transmission member and the driving end.

19. The driving mechanism of claim 17, wherein the mounting member of the first linear driving module defines an opening;
the third transmission member comprises a first fixing portion and a second fixing portion located upon the first fixing portion;
the first fixing portion is sleeved on the second transmission member, opposite sides of the second fixing portion is supported on sides of the mounting member and the mounting member guides the second fixing portion;
the second fixing portion defines a receiving groove at a top surface thereof;
the first linear driving module further comprises a protecting plate matching with the mounting member;
the protecting plate is partly received in the receiving groove to cover the opening;
the mounting member of the second linear driving module is coupled to the second fixing portion.

20. The driving mechanism of claim 17, wherein the second linear driving module further comprises a connecting member, the connecting member of the second linear driving module comprises a first connecting portion and a second connecting portion perpendicularly fixed to the first connecting portion;
the first connecting portion is fixed to the third transmission member of the first linear driving module; and
the mounting member of the second linear driving module is fixed to the second connecting portion.
